(19) United States
(12) Patent Application Publication
(10) Pub. No.: US 2008/0090107 A1
(43) Pub. Date: Apr. 17, 2008

(54) Integrated thermal management of a fuel cell and a fuel cell powered device

(76) Inventors: John Perry Scartozzi, Clifton Park, NY (US); James K. Prueitt, Dedham, MA (US); Ashish K. Modi, Philadelphia, PA (US); Charles M. Carlstrom, Saratoga Springs, NY (US)

Correspondence Address: CESARI AND MCKENNA, LLP, 88 BLACK FALCON AVENUE, BOSTON, MA, 02210, US

(21) Appl. No.: 11/580,550

(22) Filed: Oct. 13, 2006

(51) Int. Cl. H01M 14/00

(52) U.S. Cl. 429/7

(57) ABSTRACT

An integrated thermal management of an electrochemical energy conversion device (e.g., a fuel cell) and an electronic device powered by the electrochemical energy conversion device is described. According to the present invention, an integrated thermal management interface may be used to intentionally manage and control the heat generated by both devices in a shared and efficient manner (e.g., in addition to natural heat dissipation). In particular, the interface may be a unified sub-system, which may be electrical or mechanical (or a combination of both), used to actively control the heat of the two distinct devices, i.e., the heat-generating portions of the two devices, by creating a thermally conductive path to a shared heat dissipation mechanism. In accordance with aspects of the present invention, the interface may be embodied as one or more shared thermally conductive paths, fans, air pumps, heat sinks, switches, etc.

### CROSS REFERENCE TO RELATED APPLICATIONS

The present invention is related to commonly owned copending U.S. patent application Ser. No. 11/021,971 for an APPARATUS AND METHOD FOR VARIABLE CONDUCTANCE TEMPERATURE CONTROL, filed by Becerra et al. on Dec. 23, 2004, the contents of which are hereby incorporated by reference in its entirety.

### BACKGROUND OF THE INVENTION

1. Field of the Invention

This invention relates generally to electrochemical energy conversion devices (e.g., a fuel cell) and electronic devices powered by the electrochemical energy conversion devices, and, more particularly, to integrated thermal management of the devices.

2. Background Information

Electrochemical energy conversion devices, generally, are devices that convert one or more chemicals into energy (i.e., electricity) through one or more chemical reactions. In particular, fuel cells are an example of such a device in which electrochemical reactions are used to generate electricity from fuel and oxygen. A variety of materials may be suited for use as a fuel depending upon the materials chosen for the components of the cell. Organic materials in liquid form, such as methanol are attractive fuel choices due to the high specific energy.

Fuel cell systems may be divided into “reformer-based” systems (i.e., those in which the fuel is processed in some fashion to extract hydrogen from the fuel before the hydrogen is introduced into the fuel cell system) or “direct oxidation” systems in which the fuel is fed directly into the cell without the need for separate internal or external fuel processing. Many currently available fuel cells are reformer-based. However, because fuel processing is complex and generally requires costly components which occupy significant volume, reformer based systems are more suitable for comparatively high power applications.

Direct oxidation fuel cell systems may be better suited for use with smaller mobile devices (e.g., mobile phones, handheld and laptop computers, etc.), as well as for somewhat larger scale applications. In direct oxidation fuel cells, a carbonaceous liquid fuel (typically methanol or an aqueous methanol solution) is directly introduced to the anode face of a membrane electrode assembly (MEA).

One example of a fuel cell system is the direct methanol fuel cell or DMFC system. In a DMFC system, a mixture comprised of methanol, predominantly methanol or methanol and water is used as fuel (the “fuel mixture”), and oxygen, preferably from ambient air, is used as the oxidant. The fundamental reactions are the anodic oxidation of the fuel mixture into CO₂, protons, and electrons; and the cathodic combination of protons, electrons, and oxygen into water. Both reactions notably take place at and within the MEA.

Typical DMFC systems include a fuel source, fluid and effluent management systems, and air management systems, as well as the direct methanol fuel cell (“fuel cell”) itself. The fuel cell typically also consists of a housing, hardware for current collection, fuel and air distribution, and one or more MEAs disposed within the housing. Further details of the operation of an illustrative direct oxidation fuel cell are discussed in detail in commonly-owned U.S. Pat. No. 6,981,877 of Ren et al. for a SIMPLIFIED DIRECT OXIDATION FUEL CELL SYSTEM, which issued on Jan. 3, 2006, the contents of which are incorporated herein by reference in its entirety.

Transportable fuel cells (e.g., direct oxidation fuel cells or other electrochemical energy conversion devices) may be particularly suited for use with small portable electronic devices based on the sufficiency of such fuel cells' power output and the ability to manufacture the comparatively simple direct oxidation fuel cell system on a micro-level. Example portable devices used by individuals may include, e.g., mobile telephones, personal digital assistants (PDAs), other communication devices, GPS positioning and location devices, tracking devices, beepers, weaponry, listening aids, and other equipment of an electronic nature.

During optimal steady state operation, fuel cells operate at temperatures that are generally higher than ambient air temperatures, with most operating between 30° and 80° C., depending on the application for which the fuel cell is providing power and the design of the fuel cell system. The performance of a fuel cell (and therefore the fuel cell power system) is related to the temperature of the fuel cell. For example, if the temperature is too low, then the electrochemical reactions may not occur at a rate that provides optimum power output. Similarly, if the temperature of the fuel cell is raised too much, the performance of the fuel cell may be compromised. By their nature, as will be understood by those skilled in the art, today's fuel cell systems may be inefficient, producing excess heat that may adversely affect the fuel cell's operation.

Electronic devices (systems and components), including those which may be powered by electrochemical energy conversion devices (e.g., fuel cells), can become overheated, thus compromising their performance. It is especially difficult to effectively address thermal management issues on a volumetric scale that is consistent with providing a device and associated electrochemical energy conversion device where space, weight, volume, and dimensions are critical parameters. In such devices, it is desirable to minimize the number of components dedicated to cooling the system. Also, as mobile devices become more powerful and require more power, mobile device components produce increasing amounts of heat. Accordingly, for many systems it is becoming increasingly important to remove heat from the electronic components and systems.

Notably, by combining the heat generated by an electronic device with the heat generated by the electrochemical energy conversion devices used to power the device, both the electronic device and the electrochemical energy conversion device may suffer from the increased heat. In order to optimize performance of the devices, it is desired to manage and control the generated heat in such a way as to maintain optimal operating temperatures of both devices. In particular, however, due to the small form factor of most portable electronic devices powered by electrochemical energy conversion devices, separate heat management and control for each heat source may be an inefficient use of space and energy.

There remains a need, therefore, for an apparatus and method that provide integrated thermal management and temperature control for electrochemical energy conversion devices and electronic devices powered by the electrochemical energy conversion devices. It is thus an object of the present invention to provide such an apparatus and method which controls temperature in an integrated system.

### SUMMARY OF THE INVENTION

The present invention is directed to providing integrated thermal management of an electrochemical energy conversion device (e.g., a fuel cell) and an electronic device powered by the electrochemical energy conversion device. According to the present invention, an integrated thermal management interface may be used to intentionally manage and control the heat generated by both devices in a shared and efficient manner (e.g., in addition to natural heat dissipation). In particular, the interface may be a unified sub-system, which may be electrical or mechanical (or a combination of both), used to actively control the heat of the two distinct devices, i.e., the heat-generating portions of the two devices, by creating a thermally conductive path to a shared heat dissipation mechanism. In accordance with aspects of the present invention, the interface may be embodied as one or more shared thermally conductive paths, fans, air pumps, heat sinks, switches, etc.

Advantageously, the novel system provides integrated thermal management of an electrochemical energy conversion device and an electronic device powered by the electrochemical energy conversion device. In particular, by providing an interface between the heat-generating portions of each device, the novel system may efficiently manage heat of both devices, e.g., using shared heat dissipation mechanisms. Also, the novel shared interface system may reduce heat management space conventionally required by separate heat management systems, as will be understood by those skilled in the art.

### BRIEF DESCRIPTION OF THE DRAWINGS

The above and further advantages of the invention may be better understood by referring to the following description in conjunction with the accompanying drawings in which like reference numerals indicate identically or functionally similar elements, of which:

FIG. 1 is a simplified schematic block diagram of one embodiment of an electronic device that may be powered by an electrochemical energy conversion device and advantageously used with the present invention;

FIG. 2 is a simplified schematic block diagram of one embodiment of the electronic device that may be advantageously used with the present invention;

FIGS. 3A and 3B are simplified schematic block diagrams of other embodiments of the electronic device that may be advantageously used with the present invention; and

FIG. 4 is a simplified schematic block diagram of an integrated heat management interface that may be advantageously used with the present invention.

### DETAILED DESCRIPTION OF AN ILLUSTRATIVE EMBODIMENT

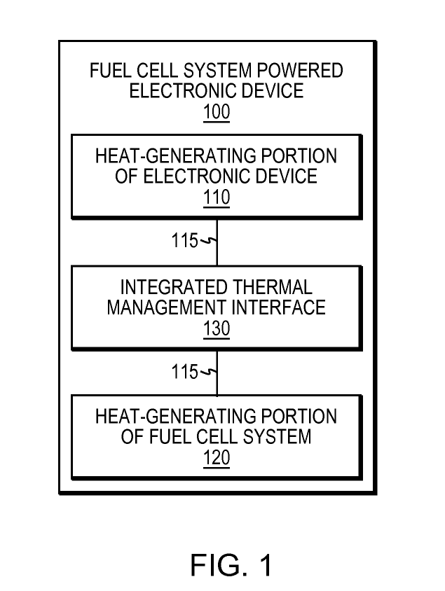

FIG. 1 is a simplified schematic block diagram of one embodiment of an electronic device 100 that may be powered by an electrochemical energy conversion device and advantageously used with the present invention. As will be understood by those skilled in the art, the electronic device may have a heat-generating portion 110, such as, e.g., from various processors, power converters, visual displays, or other components that may generate heat during their operation.

Illustratively, the electrochemical energy conversion device (and heat-generating portion thereof) 120 is a fuel cell system, e.g., a direct oxidation fuel cell, direct methanol fuel cell (DMFC), liquid or vapor feed fuel cell, portable fuel cell, transportable reformer-based fuel cell system, or other electrochemical energy conversion device (including other forms of fuel cells), as will be understood by those skilled in the art.

Notably, there are many different electrochemical energy conversion devices that may benefit from integrated temperature control to which the apparatus and techniques of the present invention may be employed. By way of example, the fuel cell system 120 may be a direct oxidation fuel cell, including an individual fuel cell, a fuel cell array or a fuel cell stack. Alternatively, the fuel cell system 120 may be any of a variety of other devices including, but not limited to a catalytic reactor, a system that uses one or more heat transfer fluids, and/or other temperature controlled devices. Moreover, the system 100 actually embodying the invention may include a number of other components, or may omit certain components shown, while remaining within the scope of the present invention. The example view shown herein is for simplicity, and is merely representative.

The illustrative embodiment of the invention uses a fuel cell system 120 (e.g., a DMFC) with the fuel substance being substantially comprised of methanol (e.g., neat methanol) or a substantially comprised of a mixture of methanol and water. It should be understood, however, that it is within the scope of the present invention that other fuels may be used in an appropriate fuel cell. Thus, as noted, the word “fuel” shall include a substance that is substantially comprised of alcohols such as methanol and ethanol, alcohol precursors, dimethyloxymethane, methylorthoformate or combinations thereof and aqueous solutions thereof, and other carbonaceous substances amenable to use in electrochemical energy conversion devices. Furthermore, it should be understood that the fuel substance itself may be in the form of a higher viscosity fuel, a vapor, a liquid, or a combination of any of these fluidic forms, and the invention is not limited to use with any particular fuel type and/or fuel form.

As will be understood by those skilled in the art, heat is generated during the electrochemical energy conversion reaction, e.g., in heat-generating portion 120 of the fuel cell system. This heat can be useful in terms of warming the electrochemical energy conversion device in a cold environment and ensuring that the reactions occur at a rate that is sufficient to generate the desired power and current to provide power to the electronic device. However, in other operating circumstances, the heat can build up and result in a loss of efficiency and lower power output of the electrochemical energy conversion device. This heat, in addition to the heat generated by the heat-generating portion 110 of the electronic device 100, may be managed and controlled (e.g., dissipated) in an integrated manner in accordance with the present invention.

The present invention is directed to providing integrated thermal management of an electrochemical energy conversion device (e.g., a fuel cell) and an electronic device powered by the electrochemical energy conversion device. According to the present invention, an integrated thermal management interface 130 may be used to intentionally manage and control the heat generated by both devices in a shared and efficient manner (e.g., in addition to natural heat dissipation). In particular, the interface 130 may be a unified sub-system, which may be electrical or mechanical (or a combination of both), used to actively control the heat of the two distinct devices, i.e., the heat-generating portions of the two devices, by creating a thermally conductive path to a shared heat dissipation mechanism. For instance, in a simple embodiment, the integrated thermal management interface 130 may be a shared heat sink (described below). In accordance with this and other aspects of the present invention, the interface may be illustratively embodied as one or more shared thermally conductive paths, fans, air pumps, heat sinks, switches, etc.

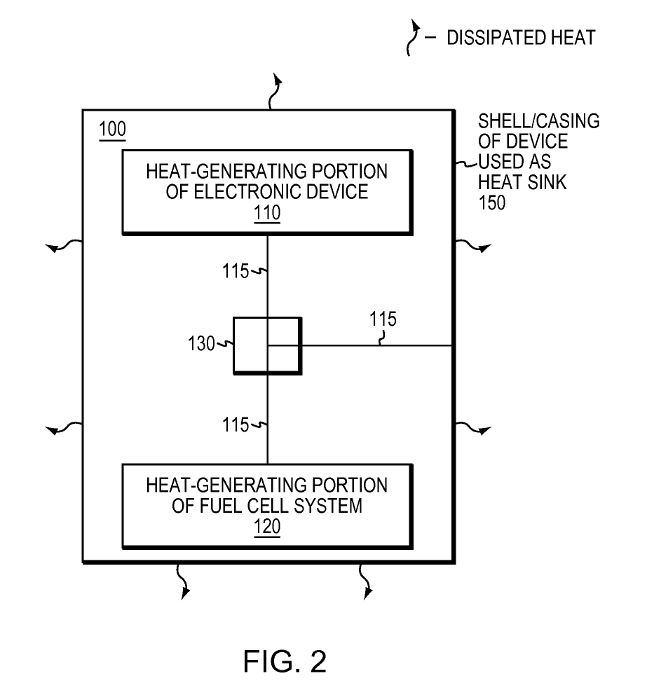

In accordance with one aspect of the present invention, the interface 130 interconnects one or more thermally conductive conduits, for example heat pipes 115 from the heat portions 110 and 120 to a shared heat sink. FIG. 2 is a simplified schematic block diagram of one embodiment of the electronic device 100 that may be advantageously used with the present invention. According to this aspect of the present invention, the shared heat sink 150 is an available surface (e.g., external shell/casing) of the electronic device 100. For instance, the outer surface (or “skin”) of the electronic device 100 is in thermal communication with the ambient environment, thus dissipating the heat into the environment. In addition to natural heat dissipation, however, the present invention utilizes the interface 130 to combine the heat generated by heat-generating portions 110 and 120 to share a single conductive conduit 115 to direct the generated heat to certain areas of the outer surface.

Notably, the conductive conduits 115 may comprise a known thermally conductive material, such as, e.g., copper, or may be conduits for thermally conductive fluids/gases, such as ambient air, water, etc., or, alternatively or in addition, may comprise heat pipes or other apparatuses to provide for the efficient distribution of heat. The conductive conduits 115 may be arranged in thermal communication with the heat-generating portions 110 and 120 (as well as the heat sink 150) in a manner that efficiently transfers heat from the heat-generating portions (or to the heat-dissipating portion of the heat sink). For example, in addition to thermal proximity (e.g., physical contact) of the thermally conductive material/fluid/gas of the conductive conduits 115, other heat-transitive materials may be used to provide a thermal path to the conductive conduits 115, such as thermal grease, etc. Also, various serpentine paths may be utilized, as will be understood by those skilled in the art, to ensure maximal heat transfer to and from the conductive conduits 115 as this increases the surface area available for heat transfer.

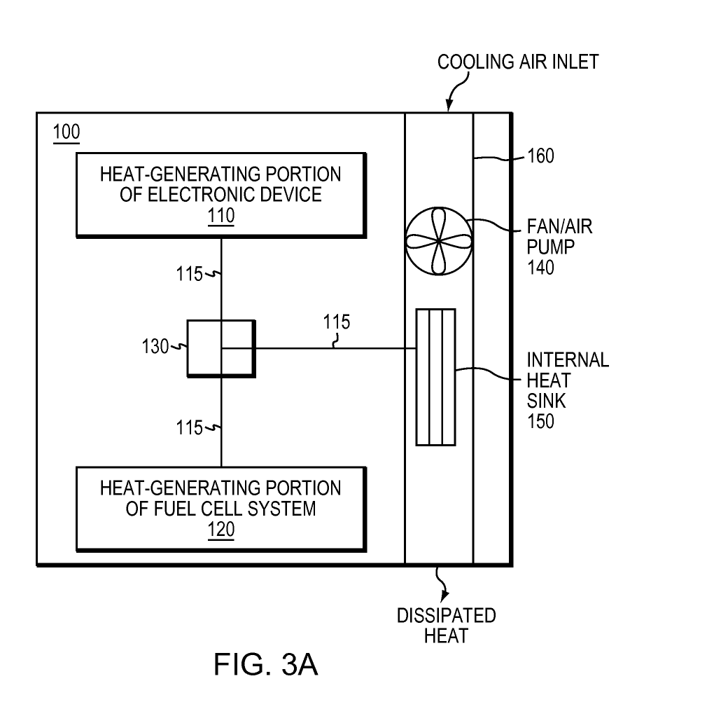

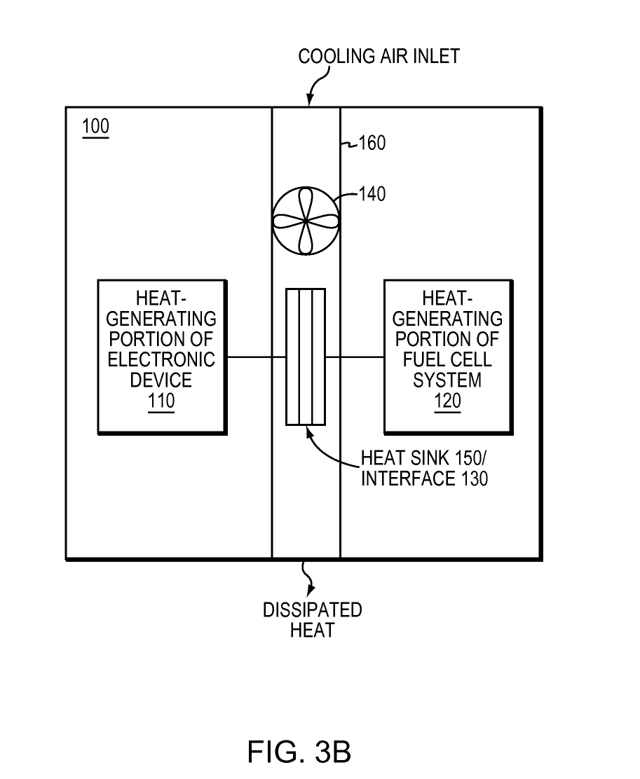

In accordance with another aspect of the present invention, the interface 130 also interconnects one or more thermally conductive conduits 115 from the heat portions 110 and 120 to a shared dedicated heat sink. FIG. 3A is a simplified schematic block diagram of another embodiment of the electronic device 100 that may be advantageously used with the present invention. According to this aspect of the present invention, the shared dedicated heat sink 150 is a dedicated heat sink that may be explicitly designed with fins, holes, slats, or other conventional techniques as necessary to facilitate heat dissipation, as will be understood by those skilled in the art. At least a portion of the heat sink 150 may be externally located on the electronic device 100 to dissipate heat convectively (through convection) into the ambient air, or, illustratively as shown, the entire heat sink 150 may be contained within the device 100, in this case disposed within an internal conduit area 160.

In particular, conduit 160 may be utilized to receive cooler ambient air and to dissipate heat past the heat sink 150. One or more fans/air pumps 140 (or, generally, “airflow actuators”) may be contained and utilized within the conduit 160 in order to provide a greater volume of forced air convective cooling to the heat sink 150, as will be understood by those skilled in the art (e.g., for when natural heat dissipation of the heat sink 150 is not sufficient). Notably, the interface 130 may be configured to electronically adjust the rate of air flowing through the conduit 160 by controlling the speed of the fan/air pump 140 accordingly. For instance, as described below, various temperature sensors may be utilized to determine when a heat-generating portion 110 and/or 120 is reaching critical temperatures, and requires greater heat dissipation.

In accordance with this aspect of the present invention, the interface 130 thermally couples the heat-generating portions 110 and 120 to a single, shared heat dissipation mechanism, i.e., the heat sink 150 (and conduit 160). FIG. 3B is a simplified schematic block diagram of an alternative embodiment of the electronic device 100 that may be advantageously used with the present invention. Specifically, the interface 130 is integrated into, mechanically fastened, or otherwise consolidated with the heat sink 150, in that the shared air conduit 160 located between the heat-generating portions 110 and 120. In other words, the shared heat dissipation mechanism of the single shared heat sink 150 provides the integrated thermal management interface 130 for the two heat-generating portions 110 and 120 of the electronic device 100 in accordance with the present invention, as opposed to a dedicated interface 130 as in FIG. 3A.

Those skilled in the art will understand that the arrangement of components of the electronic device 100 as shown herein are merely representative, and that other arrangements/locations may be utilized that are within the scope of the present invention, and are in fact, to be expected. For example, rather than separating the heat-generating portions 110 and 120 by the conduit 160, the heat-generating portions may be located on anywhere within the device 100, and have conductive conduits 115 that meet at the shared heat sink 150 as in FIG. 3B, rather than a dedicated interface 130 as in FIG. 3A. Also, while various components are shown in the figures, those skilled in the art will understand that simpler embodiments may exist, such as, e.g., a heat sink 150 without a dedicated air conduit 160 or fans/pumps 140. Further, it may be beneficial for the heat generating portions 110 and 120 of the device 100 to use a common heat conduit 115 without the need for a discrete interface (embodiment not shown). Moreover, those skilled in the art will understand that while the exemplary figures as shown herein depict two-dimensional representations, the actual embodiments of the invention will allow for flexibility in each physical dimension.

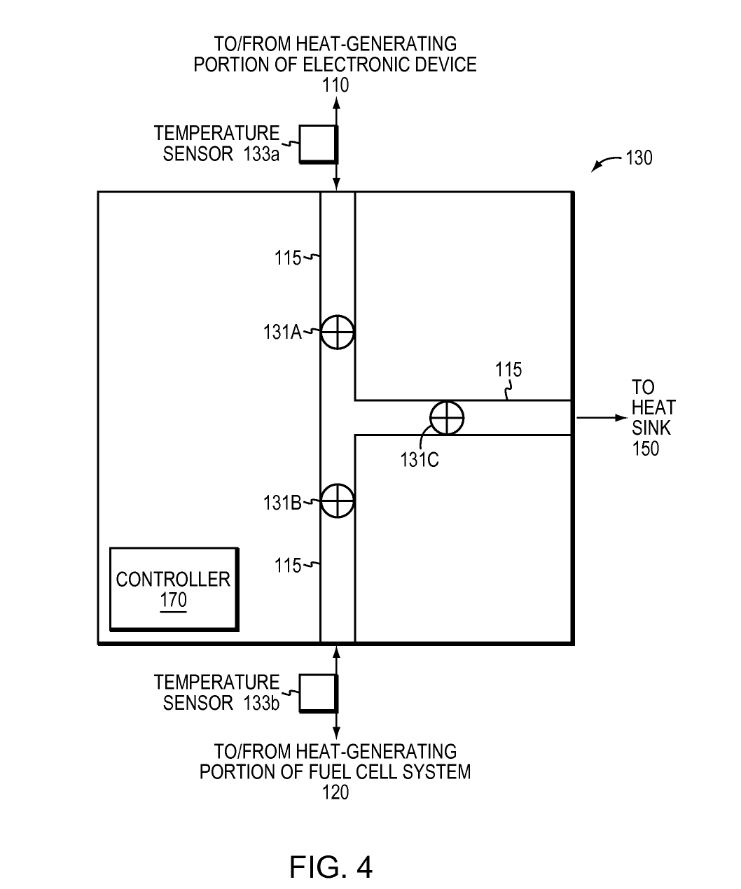

In accordance with yet another aspect of the present invention, the integrated heat management interface 130 may contain and/or communicate with one or more active control components. FIG. 4 is a simplified schematic block diagram of an integrated heat management interface 130 that may be advantageously used with the present invention. In particular, thermally conductive conduits 115 to/from the heat-generating portions 110 and 120 and to the heat-dissipating heat sink 150 may comprise one or more switches/valves or other thermal flow interrupters 131. For instance, the interface 130 may electronically and/or mechanically control the flow of heat (e.g., the flow of heated fluid or gas) by opening or closing (or limiting) the valves 131. For example, if a temperature sensor 133a indicates that the electronic device 100 (not shown) is overheating. The interface 130 may close the valve 131b to the fuel cell system 120 (temporarily), and open the valves 131a and 131c between the heat-generating portion of the electronic device 110 and the heat sink 150. In this way, a more dedicated heat dissipation of the overheating device may be accomplished. The same technique may be applied to supply dedicated heat dissipation for the fuel cell system 120 as well (e.g., according to temperature sensor 133b).

Also, a controller 170 may also be included within the electronic device 100, e.g., as shown within the integrated heat management interface 130 of FIG. 4. The controller 170 may be used to dynamically control the switches/valves 131, fans/pumps 140, heat sinks 150, etc., in response to one or more logic determinations or pre-configured policies, for example, in response to the temperature sensors 133, etc. The controller 170 may be embodied as hardware, software, or firmware (or combinations thereof), as will be understood by those skilled in the art.

Notably, in accordance with yet another aspect of the present invention, there may be circumstances when heat may be beneficially transferred directly between the electronic device 100 and the fuel cell system 120. For example, in the event the fuel cell system 120 actually requires more heat, and the electronic device's heat-generating portion is supplying heat, the integrated heat management system 130 may control the valves/switches to allow heat to flow between the devices, and not to the heat sink 150 accordingly. In other words, by actively controlling (e.g., opening/closing/etc.) valves/switches 131, the interface 130 of the present invention may efficiently and advantageously raise and/or lower (manage) the heat of the devices.

Temperature sensors 133 may be implemented using any of a variety of commercially available direct temperature measurement devices, such as a thermocouple, and may be located within the interface 130, or at the respective devices and in communication with the interface 130. Alternatively, an indirect method of temperature measurement may be used, including, but not limited to measuring the voltage or current produced by fuel cell system 120. This is possible because it is known that the operating temperature of fuel cell system 120 is closely related to its power output. Thus, by measuring the voltage at a given current or current at a given voltage produced by fuel cell system 120, the temperature may be calculated or obtained by reference to a lookup table based on the power/temperature relationship. Other relationships exist that may be used to indirectly measure the temperature of the fuel cell system 120, including, for example only, the generation of carbon dioxide and water over given periods of time.

In other embodiments, the associated components may be controlled using thermally sensitive materials, such as bimetallic strips or other heat-sensitive assemblies to actuate a valve, or activate a component. For example, an exemplary heat switch that may be used with the present invention is described in above-incorporated U.S. patent application Ser. No. 11/021,971 for an APPARATUS AND METHOD FOR VARIABLE CONDUCTANCE TEMPERATURE CONTROL. In particular, where conductive conduit 115 is a thermally conductive material, a heat switch has two movable opposing surfaces, so that heat is substantially conducted from one surface to another when the surfaces are in contact and is substantially blocked when the surfaces are moved apart.

Advantageously, the novel system provides integrated thermal management of an electrochemical energy conversion device and an electronic device powered by the electrochemical energy conversion device. In particular, by providing an interface between the heat-generating portions of each device, the novel system may efficiently manage heat of both devices, e.g., using shared heat dissipation mechanisms. Also, the novel shared interface system may reduce heat management space conventionally required by separate heat management systems, as will be understood by those skilled in the art.

While there has been shown and described an illustrative embodiment that provides integrated thermal management of an electrochemical energy conversion device and an electronic device powered by the electrochemical energy conversion device, it is to be understood that various other adaptations and modifications may be made within the spirit and scope of the present invention. For example, the invention has been shown and described herein using a fuel cell as the electrochemical energy conversion device. However, the invention in its broader sense is not so limited, and may, in fact, be used with other electrochemical energy conversion devices that require storage of chemicals (e.g., fuel) that may be delivered to the device, as will be understood by those skilled in the art. Further, while the invention has been shown and described herein for use with direct oxidation fuel cell systems (e.g., DMFCs), the invention is equally as applicable to reformer-based systems. For instance, while reformer-based systems are generally larger in size, smaller (e.g., transportable) reformer-based fuel cell systems may advantageously utilize integrated thermal management and control of the present invention with devices powered by the reformer-based fuel cell systems, as will be understood by those skilled in the art.

The foregoing description has been directed to specific embodiments of the invention. It will be apparent, however, that other variations and modifications may be made to the described embodiments, with the attainment of some or all of the advantages of such. Accordingly this description is to be taken only by way of example and not to otherwise limit the scope of the invention. Therefore, it is the object of the appended claims to cover all such variations and modifications as come within the true spirit and scope of the invention.

What is claimed is:

1. An integrated thermal management system, comprising:
an electrochemical energy conversion device having a first heat-generating portion;
an electronic device powered by the electrochemical energy conversion device, the electronic device having a second heat-generating portion; and
an integrated thermal management interface adapted to intentionally manage and control heat generated by the first and second heat-generating portions.

2. The integrated thermal management system as in claim 1, wherein the electrochemical energy conversion device is a fuel cell system.

3. The integrated thermal management system as in claim 2, wherein the fuel cell system is a direct methanol fuel cell (DMFC) system.

4. The integrated thermal management system as in claim 1, wherein the second heat-generating portion is at least one of one or more processors, power converters, and visual displays.

5. The integrated thermal management system as in claim 1, wherein the integrated thermal management interface is adapted to manage and control heat in at least one of an electrical manner or a mechanical manner.

6. The integrated thermal management system as in claim 1, further comprising:
a shared heat dissipation mechanism, wherein the integrated thermal management interface is adapted to intentionally manage and control heat by a connection of the first and second heat-generating portions to the shared heat dissipation mechanism.

7. The integrated thermal management system as in claim 6, wherein the connection comprises one or more thermally conductive conduits.

8. The integrated thermal management system as in claim 6, wherein the heat dissipation mechanism is a heat sink.

9. The integrated thermal management system as in claim 6, further comprising:
a surface of the electronic device, wherein the shared heat dissipation mechanism is the surface.

10. The integrated thermal management system as in claim 6, wherein the shared heat dissipation mechanism is external to electronic device.

11. The integrated thermal management system as in claim 6, wherein the shared heat dissipation mechanism is internal to electronic device, the system further comprising:
one or more conduits adapted to allow heat to flow from the shared heat dissipation mechanism to a location external to the electronic device.

12. The integrated thermal management system as in claim 11, wherein the one or more conduits are adapted to bring ambient air to the shared heat dissipation mechanism.

13. The integrated thermal management system as in claim 11, further comprising:
one or more airflow actuators adapted to control the flow of heat within the one or more conduits.

14. The integrated thermal management system as in claim 13, wherein the one or more fans are adapted to control the flow of heat within the one or more conduits based on one or more temperatures of at least one of the first heat-generation portion, the second heat-generating portion, the shared heat dissipation mechanism, and an ambient environment surrounding the electronic device.

15. The integrated thermal management system as in claim 1, further comprising:
one or more temperature sensors.

16. The integrated thermal management system as in claim 15, wherein the integrated thermal management interface is adapted to intentionally manage and control heat based on one or more temperatures sensed by the one or more temperature sensors.

17. The integrated thermal management system as in claim 1, wherein the integrated thermal management interface is adapted to actively manage and control heat.

18. The integrated thermal management system as in claim 17, further comprising:
one or more valves controlled by the integrated thermal management interface and adapted to control heat flow between the first heat-generation portion, the second heat-generating portion, the shared heat dissipation mechanism, and an ambient environment surrounding the electronic device.

19. The integrated thermal management system as in claim 18, wherein the integrated thermal management interface is adapted to adjust the one or more valves to remove heat from at least one or the first heat-generation portion, the second heat-generating portion, and the shared heat dissipation mechanism.

20. The integrated thermal management system as in claim 18, wherein the integrated thermal management interface is adapted to adjust the one or more valves to add heat to at least one or the first heat-generation portion, the second heat-generating portion, and the shared heat dissipation mechanism.
